(19) United States
(12) Patent Application Publication
(10) Pub. No.: US 2023/0420708 A1
(43) Pub. Date: Dec. 28, 2023

(54) VESSEL FOR A FUEL CELL, A FUEL CELL SYSTEM, AND A METHOD FOR MAINTAINING A NON-EXPLOSIVE ATMOSPHERE IN A VESSEL FOR A FUEL CELL

(71) Applicant: Teledyne Energy Systems, Inc., Thousand Oaks, CA (US)

(72) Inventors: Robert K. Wynne, New Freedom, PA (US); Thomas I. Valdez, Timonium, MD (US); Johnny D. Alston, Seven Valleys, PA (US); Brianna M. Warrenfeltz, Middletown, MD (US)

(21) Appl. No.: 18/322,845

(22) Filed: May 24, 2023

Related U.S. Application Data
(60) Provisional application No. 63/366,813, filed on Jun. 22, 2022.

(51) Int. Cl. H01M 8/04082; H01M 4/92; H01M 8/04119; H01M 8/04955; H01M 8/04828; H01M 8/04492; H01M 8/0438

(52) U.S. Cl. CPC H01M 8/04201; H01M 4/926; H01M 8/04156; H01M 8/04955; H01M 8/04835; H01M 8/04507; H01M 8/045; H01M 8/04388; H01M 8/04395

(57) ABSTRACT

The present disclosure relates to a vessel for a fuel cell, a fuel cell system, and a method for maintaining a non-explosive atmosphere in a cavity of a vessel for a fuel cell. The vessel comprises a wall defining a cavity, and a catalyst. The cavity comprises a non-explosive atmosphere comprising predominantly hydrogen gas or predominantly oxygen gas. The cavity is configured to receive the fuel cell. The catalyst is in contact with the non-explosive atmosphere in the cavity and the catalyst is configured to convert hydrogen gas and oxygen gas into water.

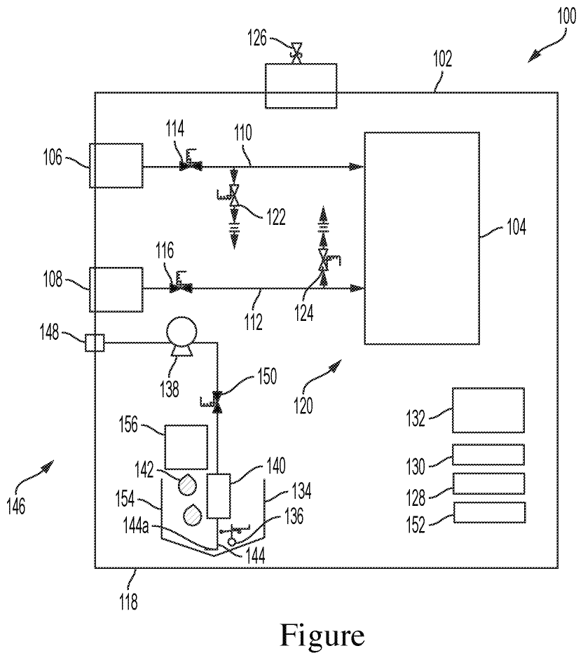

### CROSS REFERENCE

This application claims priority to U.S. Provisional Patent Application No. 63/366,813, filed on Jun. 22, 2022, the contents of which are hereby incorporated by reference into this specification.

### FIELD OF USE

The present disclosure relates to a vessel for a fuel cell, a fuel cell system, and a method for maintaining a non-explosive atmosphere in a cavity of a vessel for a fuel cell.

### BACKGROUND

Fuel cells generally operate by reacting a fuel and an oxidant to produce electricity, heat, and chemical reaction products. For example, fuel cells utilizing hydrogen gas as a fuel and oxygen gas as an oxidant generate electricity, heat, and water. There are challenges with operating fuel cells in closed environments.

### SUMMARY

One non-limiting aspect according to the present disclosure is directed to a vessel for a fuel cell. The vessel comprises a wall defining a cavity, and a catalyst. The cavity comprises a non-explosive atmosphere comprising predominantly hydrogen gas or predominantly oxygen gas. The cavity is configured to receive the fuel cell. The catalyst is in contact with the non-explosive atmosphere in the cavity, and the catalyst is configured to convert hydrogen gas and oxygen gas into water.

A further non-limiting aspect according to the present disclosure is directed to a fuel cell system comprising a vessel constructed according to the present disclosure and a fuel cell in the vessel.

Yet another non-limiting aspect according to the present disclosure is directed to a method for maintaining a non-explosive atmosphere in a cavity of a vessel for a fuel cell. The method comprises receiving a first gas from the fuel cell into the cavity of the vessel. The first gas comprises predominantly hydrogen gas or predominantly oxygen gas. Prior to receiving the first gas, the cavity comprises a non-explosive atmosphere comprising a second gas. The second gas differs from the first gas and comprises predominantly hydrogen gas or predominantly oxygen gas. At least a portion of the first gas and the second gas are converted to water in the cavity utilizing a catalyst.

It will be understood that the inventions disclosed and described herein are not limited to the aspects summarized in this Summary. The reader will appreciate the foregoing details, as well as others, upon considering the following detailed description of various non-limiting and non-exhaustive aspects according to the present disclosure.

### BRIEF DESCRIPTION OF THE DRAWINGS

The features and advantages of the examples presented herein, and the manner of attaining them, will become more apparent, and the examples will be better understood, by reference to the following description taken in conjunction with the accompanying drawing, wherein:

The FIGURE is a schematic process and instrumentation diagram showing certain elements of a non-limiting embodiment of a fuel cell system according to the present disclosure.

The exemplifications set out herein illustrate certain non-limiting embodiments, in one form, and such exemplifications are not to be construed as limiting the scope of the appended claims and the invention in any manner.

### DETAILED DESCRIPTION OF NON-LIMITING EMBODIMENTS

Various examples are described and illustrated herein to provide an overall understanding of the structure, function, and use of the disclosed systems, apparatus, parts, assemblies, and methods. The various examples described and illustrated herein are non-limiting and non-exhaustive. Thus, the invention is not limited by the description of the various non-limiting and non-exhaustive examples disclosed herein. Features and characteristics illustrated and/or described in connection with various examples herein may be combined with features and characteristics of other examples herein. Such modifications and variations are intended to be included within the scope of the present disclosure. The various non-limiting embodiments disclosed and described in the present disclosure can comprise, consist of, or consist essentially of the features and characteristics as variously described herein.

Any references herein to “various non-limiting embodiments”, “some non-limiting embodiments”, “certain non-limiting embodiments”, “one non-limiting embodiment”, “a non-limiting embodiment”, “an embodiment”, “one embodiment”, or like phrases mean that a particular feature, structure, act, or characteristic described in connection with the example is included in at least one embodiment. Thus, appearances of the phrases “various non-limiting embodiments”, “some non-limiting embodiments”, “certain non-limiting embodiments”, “one non-limiting embodiment”, “a non-limiting embodiment”, “an embodiment”, “one embodiment”, or like phrases in the specification do not necessarily refer to the same non-limiting embodiment. Furthermore, the particular described features, structures, or characteristics may be combined in any suitable manner in one or more non-limiting embodiments. Thus, the particular features, structures, or characteristics illustrated or described in connection with one non-limiting embodiment may be combined, in whole or in part, with the features, structures, or characteristics of one or more other non-limiting embodiments without limitation. Such modifications and variations are intended to be included within the scope of the present non-limiting embodiments.

Typically, a fuel cell can comprise an anode, a cathode, and an electrolyte located intermediate the anode and the cathode. The anode and the cathode are electrically conductive, porous, and may comprise catalysts such as platinum or platinum-based materials supported on carbon nano-particles or micro-particles incorporated into the structure of the anode and the cathode. The catalyst in the anode can promote the oxidation of hydrogen (H₂) into two protons (H⁺) and two electrons (e⁻). The protons produced in the anode transport through the electrolyte to the cathode. The electrolyte can be a non-electrically-conductive Polymer Electrolyte Membrane (PEM) that is permeable to the protons, but is impermeable to the hydrogen and oxygen reactants. In various non-limiting embodiments, other fuel cell chemistries can be substituted in place of PEM. The electrons produced in the anode are collected and form an electrical current that flows from the anode, through an external electrical circuit, and into the cathode. The catalyst in the cathode promotes the reduction of oxygen (O₂) into water by reacting with the protons that transport through the electrolyte membrane from the anode and with the electrons from the external electrical circuit.

Generally, hydrogen gas and oxygen gas can be separately fed to the fuel cell as reactants. The fuel cell can be a continuous flow fuel cell or a closed loop fuel cell. In a continuous flow fuel cell, the hydrogen gas is fed through a fuel inlet and flows through an anode side flow path in contact with the anode. Excess hydrogen gas that does not oxidize to protons and electrons at or in the anode can exit the anode side flow path through an anode outlet. The oxygen gas is fed through an oxidant inlet and flows through a cathode side flow path in contact with the cathode. The water reaction product and excess oxygen gas that does not reduce to water at or in the cathode can exit the cathode outlet.

Alternately, a fuel cell can operate in a closed loop without excess reactant flow (e.g., “dead-ended” mode) wherein excess hydrogen gas and excess oxygen gas are not continuously withdrawn from the fuel cell and, instead, may be removed from the fuel cell during a reactant purge. Closed loop fuel cells can remove excess product water utilizing porous wick structures and/or hydrophilic micro-porous layers that transport water but prevent hydrogen and oxygen reactants from exiting the fuel cell until a reactant purge operation is performed.

Fuel cells come in various forms. For example, proton exchange membrane fuel cells, which also are known as “PEM” fuel cells, utilize hydrogen as fuel and oxygen as an oxidant to produce electricity, heat, and a chemical reaction product of water. The construction and operation of fuel cells generally, and of PEM fuel cells specifically, is described, for example, in F. Barbir, PEM Fuel Cells: Theory and Practice, Elsevier, 2013, and in J. Zhang, PEM Fuel Cell Electrocatalysts and Catalyst Layers: Fundamentals and Applications, Springer, 2008, which are both incorporated herein by reference in their entireties.

When a fuel cell operates in a closed environment, oxygen gas and/or hydrogen gas may build up in the closed environment because the closed environment does not have unrestricted fluid exchange with an external environment. As the oxygen gas and hydrogen gas concentration in the closed environment increases, they may form a mixture that can be explosive. It may be desirable to remove at least one of the oxygen gas and the hydrogen gas to avoid forming an explosive atmosphere. Venting the closed environment in a controlled manner into an external environment may be possible at atmospheric pressure (e.g., 1 atmosphere absolute) because the reactant pressure in the fuel cell is generally higher than the atmospheric pressure. However, if the external environment is at a higher pressure than a pressure of the closed atmosphere, venting gases from the closed environment may be inefficient and difficult. Additionally, it may not be desirable to vent the closed environment if the external environment is another closed environment or otherwise sensitive environment such as, for example, an aerospace environment. A closed environment may be flushed with an inert gas if available, but providing an inert gas leads to additional components that may be required in the system and/or an increase in size of the system.

In order to address the foregoing issues, the present inventors have developed a vessel for a fuel cell, a fuel cell system, and a method for maintaining a non-explosive atmosphere in a cavity of a vessel for a fuel cell according to the present disclosure. The FIGURE illustrates a non-limiting embodiment of a fuel cell system 100 comprising a vessel 102 and a fuel cell 104 in a cavity 120 of the vessel 102. The fuel cell system 100 can be configured to operate in an aerospace environment, a subsea environment, and/or a downhole environment (e.g., in a gas well, an oil well, or a geothermal well). In various non-limiting embodiments, the fuel cell system 100 can comprise materials and have a construction suitable to withstand corrosive environments and/or a high pressure environment.

As used herein, “a high pressure environment” means an environment in which the pressure is greater than a pressure at which the fuel (e.g., hydrogen gas) and oxidant (e.g., oxygen gas) are reacted within the fuel cell. In various non-limiting embodiments, a high pressure environment may comprise a pressure that is, for example, at least 50 pounds per square inch absolute (PSIA), such as, for example, at least 100 PSIA, at least 1,000 PSIA, at least 1,500 PSIA, at least 3,000 PSIA, at least 5,000 PSIA, or at least 10,000 PSIA. For example, the high pressure environment can comprise a pressure in a range of 50 PSIA to 10,000 PSIA, such as, for example, 50 PSIA to 5,000 PSIA, 500 PSIA to 3,000 PSIA, or 500 PSIA to 1,500 PSIA. In various non-limiting embodiments, the fuel cell system 100 is configured to operate in a subsea environment at an underwater depth at least 1,000 meters and with an external pressure of 1,500 PSIA.

The fuel cell 104 can be a fuel cell as described herein, such as, for example, a PEM fuel cell or other fuel cell type. The fuel cell 104 can be configured to generate heat, electricity, and water. The fuel cell 104 can be in fluid communication with a hydrogen gas source 106 and an oxygen gas source 108. For example, an anode side of the fuel cell 104 can be in fluid communication with the hydrogen gas source 106 via a fluid conduit 110, and a cathode side of the fuel cell can be in fluid communication with the oxygen gas source 108 via fluid conduit 112. In various non-limiting embodiments, the fluid conduit 110 can comprise a flow valve 114 configured to control fluid communication between the hydrogen gas source 106 and the anode side of the fuel cell 104, and/or the fluid conduit 112 can comprise a flow valve 116 configured to control fluid communication between the oxygen gas source 108 and the cathode side of the fuel cell 104.

The cavity 120 may be in fluid communication with the hydrogen gas source 106 and/or the oxygen gas source 108. For example, the fluid conduit 110 can comprise a flow valve 122 configured to control fluid communication between the hydrogen gas source 106 and the cavity 120, and/or the fluid conduit 112 can comprise a flow valve 124 configured to control fluid communication between the oxygen gas source 108 and the cavity 120.

In certain non-limiting embodiments, one or more of the flow valves 114, 116, 122, and 124 can be a solenoid valve. Each flow valve 114, 116, 122, and 124 can be in signal communication (e.g., wireless communication, wired communication) with a controller 132. The controller 132 can change a state of each valve 114, 116, 122, and 124. For example, the controller 132 can configure, individually, the respective flow valve 114, 116, 122, and 124 into a closed state wherein fluid flow is inhibited through the respective flow valve 114, 116, 122, and 124, or into an open state wherein fluid flow is enabled through the respective flow valve 114, 116, 122, and 124. The controller 132 can comprise hardware circuitry suitable to perform the functions described herein.

The vessel 102 comprises a wall 118 defining the cavity 120 and a catalyst 156. The cavity 120 can be a closed environment (e.g., a sealed cavity, an enclosed cavity). For example, the cavity 120 can comprise a fluid composition that is restricted from exiting the cavity 120 into an external environment 146. In various non-limiting embodiments, the cavity 120 may only receive fluid, such as, oxygen gas, hydrogen gas, and/or water, and fluid may only exit the cavity 120 through a discharge port 148 and/or valve 126.

The cavity 120 is configured to receive the fuel cell 104, and the fuel cell 104 is within the cavity 120, as illustrated in the FIGURE. For example, the cavity 120 can comprise a size and shape suitable for the fuel cell 104 to be positioned and operate within the cavity 120.

The cavity 120 comprises a non-explosive atmosphere comprising predominantly hydrogen gas or predominantly oxygen gas. As used herein, “a non-explosive atmosphere” is a fluid composition that can comprise gas, vapor, mist, and/or particles, that when exposed to an ignition source (e.g., electrical ignition source such as a spark) does not result in combustion that propagates through the fluid composition. For example, in certain non-limiting embodiments wherein the non-explosive atmosphere comprises predominantly hydrogen, the oxygen concentration in the non-explosive atmosphere is less than a lower explosive limit (LEL) for oxygen in a predominantly hydrogen atmosphere of 6%. In certain other non-limiting embodiments wherein the non-explosive atmosphere comprises predominantly oxygen, the hydrogen concentration in the non-explosive atmosphere is less than the LEL for hydrogen in a predominantly oxygen atmosphere of 4%. The non-explosive atmosphere can be at pressure in a range of, for example, 10 PSIA to 100 pounds PSIA. For purposes of the present disclosure, a non-explosive atmosphere that “predominantly” comprises a certain gas comprises greater than 50% of that gas based on the total volume of the non-explosive atmosphere. For example, a non-explosive atmosphere that predominantly comprises a certain gas may comprise at least 51% of the gas, at least 60% of the gas, at least 70% of the gas, at least 80% of the gas, at least 90% of the gas, at least 94% of the gas, at least 95% of the gas, at least 96% of the gas, or at least 99% of the gas, all based on the total volume of the non-explosive atmosphere. The non-explosive atmosphere may comprise other components, such as, for example, water (e.g., liquid water, water vapor) and inert gas (e.g., nitrogen, argon).

The non-explosive atmosphere in the cavity 120 can be created by sealing the cavity 120 and substantially removing gases and/or liquids from the cavity 120 through the valve 126 using a vacuum pump or similar device. The valve 126 can be a solenoid valve, a mechanically operated valve (e.g., a Schrader valve), or other valve type. One or more of the following can provide a non-explosive atmosphere in the cavity 120: the cavity 120 can be predominantly filled with hydrogen gas or oxygen gas by an external source through the valve 126; the cavity can be predominantly filled with hydrogen gas by the hydrogen gas source 106 using flow valve 122; and/or the cavity can be predominantly filled with oxygen gas by the oxygen gas source 108 using flow valve 124.

A pressure sensor 130 can be in the cavity 120 and configured to measure a pressure of the non-explosive atmosphere in the cavity 120. The controller 132 can be in signal communication with the pressure sensor 130, and the controller 132 can be configured to introduce hydrogen gas or oxygen gas into the cavity 120 based on a pressure measured by the pressure sensor 130. For example, if a pressure of the non-explosive atmosphere in the cavity 120 decreases below a predetermined threshold, the controller 132 can introduce hydrogen gas through flow valve 122 or oxygen gas through flow valve 124 to maintain a desired composition of the non-explosive atmosphere in the cavity 120.

A gas sensor 128 can be in the cavity 120. The gas sensor 128 can be at least one of a hydrogen sensor configured to measure a hydrogen concentration in the cavity 120 and an oxygen sensor configured to measure an oxygen concentration in the cavity 120. The controller 132 can be in signal communication with the gas sensor 128 and the fuel cell 104. The controller 132 can be configured to stop operation of the fuel cell 104 based on a measurement from the gas sensor 128 indicating that a concentration of hydrogen gas or oxygen gas in the cavity 120 meets or exceeds a predetermined threshold concentration, such as, for example, a LEL concentration for the respective gas. For example, the controller 132 can change the state of flow valve 114 and/or flow valve 116 to a closed state.

The catalyst 156 is in contact with the non-explosive atmosphere in the cavity 120. The catalyst 156 is configured to convert hydrogen gas and oxygen gas into water 142. For example, the catalyst 156 can comprise a precious metal catalyst, a non-precious metal catalyst, and/or other catalyst. A precious metal catalyst can comprise platinum, a platinum alloy, rhodium and/or a rhodium alloy. A non-precious metal catalyst can comprise manganese, a manganese alloy, copper, a copper alloy, nickel, a nickel alloy, cobalt, a cobalt alloy, iron, and/or an iron alloy. Other possible catalysts may comprise a nitride catalyst or an oxide catalyst, such as, for example, a nitroxyl oxide, a nitrogen oxide, and/or an iron doped graphitic carbon nitride (e.g., Fe-g-C₃N₄). In various non-limiting embodiments, the catalyst 156 comprises platinum or a platinum alloy.

The catalyst 156 can be affixed to a substrate within the vessel 102. The substrate can comprise at least one of a metal, a polymer, and a composite. For example, the substrate can comprise a wet-proofed carbon fiber paper. In various non-limiting embodiments, a wet-proofed carbon fiber paper is carbon fiber paper that has been treated with polytetrafluoroethylene (PTFE) (e.g., TEFLON™ brand PTFE) to increase the hydrophobicity of the carbon fiber paper such that water minimally, if at all, enters pores of the carbon fiber paper and/or otherwise blocks access to the catalyst 156.

Hydrogen gas and/or oxygen gas may be introduced into the cavity 120 unintentionally. For example, a fitting and/or connection may leak and/or the fuel cell 104 may release hydrogen gas and/or oxygen gas into the cavity 120. Introduction of one of these gases may be tolerated, however, when both hydrogen gas and oxygen gas are introduced into the cavity 120 an explosive mixture may be formed. Maintaining a non-explosive atmosphere with predominantly oxygen or predominantly hydrogen in the cavity 120 in the presence of the catalyst 156 can minimize the presence of the non-predominant gas in the cavity 120.

For example, in certain non-limiting embodiments wherein the non-explosive atmosphere comprises predominantly oxygen gas, hydrogen gas that enters the cavity 120 can be removed from the non-explosive atmosphere by converting the received hydrogen gas into water with the catalyst 156 and using the oxygen gas present in the non-explosive atmosphere. Thereby, the concentration of hydrogen gas in the non-explosive atmosphere can be maintained at a concentration that is less than the LEL for hydrogen gas in the non-explosive atmosphere. Additionally, introduction of oxygen gas into the non-explosive atmosphere can be tolerated because the hydrogen gas is maintained below the LEL for hydrogen gas in the non-explosive atmosphere.

In certain non-limiting embodiments wherein the non-explosive atmosphere comprises predominantly hydrogen gas, oxygen gas that enters the cavity 120 can be removed from the non-explosive atmosphere by converting the received oxygen gas into water with the catalyst 156 and using the hydrogen gas present in the non-explosive atmosphere. Thereby, the concentration of oxygen gas in the non-explosive atmosphere can be maintained at a concentration that is less than the LEL for oxygen gas in the non-explosive atmosphere. Additionally, introduction of hydrogen gas into the non-explosive atmosphere can be tolerated because the oxygen gas is maintained below the LEL for oxygen gas in the non-explosive atmosphere. Storing water in the cavity 120 and/or removing water from the cavity 120 can be more efficient than separating hydrogen gas and oxygen gas, filling the cavity 120 with an inert gas, and/or otherwise attempting to store excess gas received into the cavity 120.

In various non-limiting embodiments, the vessel 102 can comprise a fan 152 configured to mix the gases within the cavity 120 such that composition of the non-explosive atmosphere is substantially homogenous.

The vessel 102 can comprise a water collection system 134 in the cavity 120. The water collection system 134 can store water 142 produced by the catalyst 156 until such time as the fuel cell system 100 can be serviced and/or the water collection system 134 can expel the water 142 from the cavity 120. For example, the water collection system 134 can comprise a container 154 suitable to store water 142 produced by the catalyst 156 and/or the container 154 can be configured to facilitate the removal of water 142 produced by the catalyst 156 through the discharge port 148. In various non-limiting embodiments, the water collection system 134 can comprise a fluid sensor 136 and a pump 138. The fluid sensor 136 can be configured to detect presence of a liquid, such as, for example, the presence of water 142 in the cavity 120 and/or container 154. In various non-limiting embodiments, the fluid sensor 136 can comprise a level switch.

The pump 138 can be configured to remove water 142 from the cavity 120 responsive to the fluid sensor 136 detecting a predetermined threshold amount of liquid in the cavity 120 and/or container 154. During operation, the vessel 102 can be oriented such that at least a portion of the water 142 produced by the catalyst 156 flows by gravity towards a fluid conduit 144 in communication with the pump 138. For example, the vessel 102 can be oriented such that at least a portion of the water 142 produced by the catalyst 156 flows into the container 154. The water 142 can fill the container 154, and an inlet 144a of the fluid conduit 144 can be positioned such that water 142 is urged into the fluid conduit 144 prior to gases when the pump 138 is activated and/or a flow valve 150 in the fluid conduit 144 is in an open state. For example, the inlet 144a can be configured to be submerged in the water 142. The flow valve 150 can be configured to control fluid communication between the discharge port 148 and the cavity 120. In certain non-limiting embodiments, the fluid conduit 144 comprises a filter 140 to remove contaminants that may be present in the water 142.

The pump 138 can be in fluid communication with a discharge port 148. The discharge port 148 can be in fluid communication with the external environment 146 such that the pump 138 can remove the liquid from the cavity 120 and expel the liquid into the external environment 146. The external environment 146 can be, for example, an aerospace environment, a subsea environment, and/or a downhole environment.

In various non-limiting embodiments, the vessel 102 can be configured to withstand a corrosive environment and/or a high pressure environment. For example, the wall 118 of the vessel 102 can comprise a material or materials suitable to withstand a corrosive environment and/or a high pressure environment, such as, for example, stainless steel, a nickel-chromium superalloy (e.g., an INCONEL alloy), and/or other suitable material.

The present disclosure also provides a method for maintaining a non-explosive atmosphere in the cavity 120 of the vessel 102 for the fuel cell 104. The method comprises receiving a first gas from the fuel cell 104 in the cavity of the vessel 102. The first gas comprises predominantly hydrogen gas or predominantly oxygen gas. Prior to receiving the first gas the cavity 120 comprises a non-explosive atmosphere comprising a second gas. The second gas differs from the first gas and comprises predominantly hydrogen gas or predominantly oxygen gas. In various non-limiting embodiments, the first gas comprises predominantly oxygen gas and the second gas comprises predominantly hydrogen gas, or the first gas comprises predominantly hydrogen gas and the second gas comprises predominantly oxygen gas.

The non-explosive atmosphere in the cavity 120 can be created by sealing the cavity 120 and substantially removing gases and/or liquids from the cavity 120. The cavity 120 can be predominantly filled with the second gas by an external source, the hydrogen gas source 106, the oxygen gas source 108, or any combination thereof that can produce a non-explosive atmosphere in the cavity 120.

The method comprises converting at least a portion of the first gas and the second gas to water 142 in the cavity 120 utilizing the catalyst 156. In various non-limiting embodiments, the method further comprises removing at least a portion of the water generated by the catalyst 156 from the cavity.

To maintain the non-explosive atmosphere in the cavity 120, the method can comprise measuring a pressure within the cavity 120 and introducing additional hydrogen gas or additional oxygen gas based on the measured pressure. In various non-limiting embodiments, introducing additional hydrogen gas or additional oxygen gas comprises opening flow valve 122 or flow valve 124.

Various aspects of non-limiting embodiments of an invention according to the present disclosure include, but are not limited to, the aspects listed in the following numbered clauses.

Clause 1. A vessel for a fuel cell, the vessel comprising:
a wall defining a cavity, the cavity comprising a non-explosive atmosphere comprising predominantly hydrogen gas or predominantly oxygen gas, wherein the cavity is configured to receive the fuel cell; and
a catalyst in contact with the non-explosive atmosphere in the cavity, the catalyst configured to convert hydrogen gas and oxygen gas into water.

Clause 2. The vessel of clause 1, wherein the catalyst comprises at least one of a precious metal catalyst, a non-precious metal catalyst, an oxide catalyst, and a nitride catalyst.

Clause 3. The vessel of any of clauses 1-2, wherein the catalyst comprises at least one of platinum, a platinum alloy, rhodium, a rhodium alloy, manganese, a manganese alloy, copper, a copper alloy, nickel, a nickel alloy, cobalt, a cobalt alloy, iron, an iron alloy, an oxide, and a nitride.

Clause 4. The vessel of any of clauses 1-3, wherein the catalyst is affixed to a substrate within the vessel.

Clause 5. The vessel of clause 4, wherein the substrate comprises at least one of a metal, a polymer, and a composite.

Clause 6. The vessel of any of clauses 4-5, wherein the substrate is wet-proofed carbon fiber paper.

Clause 7. The vessel of any of clauses 1-6, wherein the non-explosive atmosphere is at a pressure in a range of 10 pounds per square inch absolute to 100 pounds per square inch absolute.

Clause 8. The vessel of any of clauses 1-7, further comprising a water collection system in the cavity.

Clause 9. The vessel of clause 8, wherein the water collection system comprises a fluid sensor and a pump, wherein the pump is configured to remove water from the cavity responsive to the fluid sensor detecting a predetermined threshold amount of liquid in the cavity.

Clause 10. The vessel of clause 9, wherein, during operation of the fuel cell, the vessel is oriented such that water produced by the catalyst flows by gravity towards a fluid conduit in communication with the pump.

Clause 11. The vessel of any of clauses 1-10, further comprising a valve configured to introduce at least one of hydrogen gas and oxygen gas into the cavity.

Clause 12. The vessel of clause 11, further comprising:
a pressure sensor in the cavity; and
a controller in signal communication with the valve and the pressure sensor and configured to introduce hydrogen gas or oxygen gas into the cavity based on a pressure measured by the pressure sensor.

Clause 13. The vessel of any of clauses 11-12, further comprising:
a gas sensor in the cavity and comprising at least one of a hydrogen sensor and an oxygen sensor; and
a controller in signal communication with the gas sensor and configured to stop operation of the fuel cell based on a measurement from the gas sensor indicating that a concentration of hydrogen gas or oxygen gas in the cavity meets or exceeds a predetermined threshold concentration.

Clause 14. A fuel cell system comprising:
the vessel of any of clauses 1-13; and
a fuel cell in the cavity of the vessel.

Clause 15. A method for maintaining a non-explosive atmosphere in a cavity of a vessel for a fuel cell, the method comprising:
receiving a first gas from the fuel cell into the cavity of the vessel,
   wherein the first gas comprises predominantly hydrogen gas or predominantly oxygen gas,
   wherein prior to receiving the first gas the cavity comprises a non-explosive atmosphere comprising a second gas, and
   wherein the second gas differs from the first gas and comprises predominantly hydrogen gas or predominantly oxygen gas; and
converting at least a portion of the first gas and the second gas to water in the cavity utilizing a catalyst.

Clause 16. The method of clause 15, wherein the first gas comprises predominantly oxygen gas and the second gas comprises predominantly hydrogen gas.

Clause 17. The method of clause 15, wherein the first gas comprises predominantly hydrogen gas and the second gas comprises predominantly oxygen gas.

Clause 18. The method of any of clauses 15-17, further comprising removing at least a portion of the water from the cavity.

Clause 19. The method of any of clauses 15-18, further comprising:
measuring a pressure within the cavity; and
introducing additional hydrogen gas or additional oxygen gas based on the measured pressure to maintain the non-explosive atmosphere.

Clause 20. The method of clause 19, wherein introducing additional hydrogen gas or additional oxygen gas comprises opening a valve in fluid communication with a hydrogen gas source for the fuel cell or an oxygen gas source for the fuel cell.

In the present disclosure, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in the present disclosure is intended to include all higher numerical limitations subsumed therein. Accordingly, Applicant reserves the right to amend the present disclosure, including the claims, to expressly recite any sub-range subsumed within the ranges expressly recited. All such ranges are inherently described in the present disclosure.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

One skilled in the art will recognize that the herein described apparatus, systems, structures, methods, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A vessel for a fuel cell, the vessel comprising:
a wall defining a cavity, the cavity comprising a non-explosive atmosphere comprising predominantly hydrogen gas or predominantly oxygen gas, wherein the cavity is configured to receive the fuel cell; and
a catalyst in contact with the non-explosive atmosphere in the cavity, the catalyst configured to convert hydrogen gas and oxygen gas into water.

2. The vessel of claim 1, wherein the catalyst comprises at least one of a precious metal catalyst, a non-precious metal catalyst, an oxide catalyst, and a nitride catalyst.

3. The vessel of claim 1, wherein the catalyst comprises at least one of platinum, a platinum alloy, rhodium, a rhodium alloy, manganese, a manganese alloy, copper, a copper alloy, nickel, a nickel alloy, cobalt, a cobalt alloy, iron, an iron alloy, an oxide, and a nitride.

4. The vessel of claim 1, wherein the catalyst is affixed to a substrate within the vessel.

5. The vessel of claim 4, wherein the substrate comprises at least one of a metal, a polymer, and a composite.

6. The vessel of claim 4, wherein the substrate is wet-proofed carbon fiber paper.

7. The vessel of claim 1, wherein the non-explosive atmosphere is at a pressure in a range of 10 pounds per square inch absolute to 100 pounds per square inch absolute.

8. The vessel of claim 1, further comprising a water collection system in the cavity.

9. The vessel of claim 8, wherein the water collection system comprises a fluid sensor and a pump, wherein the pump is configured to remove water from the cavity responsive to the fluid sensor detecting a predetermined threshold amount of liquid in the cavity.

10. The vessel of claim 9, wherein, during operation of the fuel cell, the vessel is oriented such that water produced by the catalyst flows by gravity towards a fluid conduit in communication with the pump.

11. The vessel of claim 1, further comprising a valve configured to introduce at least one of hydrogen gas and oxygen gas into the cavity.

12. The vessel of claim 11, further comprising:
a pressure sensor in the cavity; and
a controller in signal communication with the valve and the pressure sensor and configured to introduce hydrogen gas or oxygen gas into the cavity based on a pressure measured by the pressure sensor.

13. The vessel of claim 11, further comprising:
a gas sensor in the cavity and comprising at least one of a hydrogen sensor and an oxygen sensor; and
a controller in signal communication with the gas sensor and configured to stop operation of the fuel cell based on a measurement from the gas sensor indicating that a concentration of hydrogen gas or oxygen gas in the cavity meets or exceeds a predetermined threshold concentration.

14. A fuel cell system comprising:
the vessel of claim 1; and
a fuel cell in the cavity of the vessel.

15. A method for maintaining a non-explosive atmosphere in a cavity of a vessel for a fuel cell, the method comprising:
receiving a first gas from the fuel cell into the cavity of the vessel,
wherein the first gas comprises predominantly hydrogen gas or predominantly oxygen gas,
wherein prior to receiving the first gas the cavity comprises a non-explosive atmosphere comprising a second gas, and
wherein the second gas differs from the first gas and comprises predominantly hydrogen gas or predominantly oxygen gas; and
converting at least a portion of the first gas and the second gas to water in the cavity utilizing a catalyst.

16. The method of claim 15, wherein the first gas comprises predominantly oxygen gas and the second gas comprises predominantly hydrogen gas.

17. The method of claim 15, wherein the first gas comprises predominantly hydrogen gas and the second gas comprises predominantly oxygen gas.

18. The method of claim 15, further comprising removing at least a portion of the water from the cavity.

19. The method of claim 15, further comprising:
measuring a pressure within the cavity; and
introducing additional hydrogen gas or additional oxygen gas based on the measured pressure to maintain the non-explosive atmosphere.

20. The method of claim 19, wherein introducing additional hydrogen gas or additional oxygen gas comprises opening a valve in fluid communication with a hydrogen gas source for the fuel cell or an oxygen gas source for the fuel cell.
